(19) United States
(12) Patent Application Publication
(10) Pub. No.: US 2026/0023934 A1
(43) Pub. Date: Jan. 22, 2026

(54) SYSTEMS AND METHODS FOR COMPLETING COMPLEX TASKS USING SEQUENTIAL RETRIEVAL-AUGMENTED GENERATION

(71) Applicant: Elsevier Inc., New York, NY (US)

(72) Inventor: Adrian Raudaschl, London (GB)

(73) Assignee: Elsevier Inc., New York, NY (US)

(21) Appl. No.: 19/216,116

(22) Filed: May 22, 2025

Related U.S. Application Data
(60) Provisional application No. 63/672,832, filed on Jul. 18, 2024.

(51) Int. Cl. G06F 40/35; G06F 16/338

(52) U.S. Cl. CPC G06F 40/35; G06F 16/338

(57) ABSTRACT

A method of automatically completing a task includes receiving, by a high-level planning agent, a query. The high-level planning agent outputs a high-level plan including a plurality of steps and information needed to complete the plurality of steps. The method also includes receiving, by a detailed planning agent, the query and the high-level plan. The detailed planning agent outputs a detailed plan that includes, for each step, one or more tools and one or more parameters for each tool. The method also includes receiving, by an action agent, the query and the detailed plan. The action agent automatically generates an action agent prompt that includes a function call for each tool and one or more parameters for each tool. The method also includes receiving, by a writing agent, the query and the execution output. The writing agent outputs a description of results of a completion of the tasks.

### BACKGROUND

Present large-language model (LLM) based agents perform certain tasks well but have deficiencies. Most current artificial intelligence frameworks lack determinism in their outputs and, therefore do not behave predictably on complex, multi-step tasks. Additionally, debugging LLM agents is very complex. Tracing decision paths is a tedious task in complex systems where many agents interact with one another. Further, continuous re-planning is resource-intensive and therefore produces high computational and time-wasting costs. Making agents run reliably and performantly within a production environment is challenging.

Thus, alternative LLM based systems and methods for performing complex tasks may be desired.

### BRIEF SUMMARY

In one embodiment, a method of automatically completing a task includes receiving, by a high-level planning agent, a query relating to the task, the high-level planning agent having a high-level planning trained model, where the high-level planning agent is operable to automatically generate a high-level planning agent prompt that requests a plurality of steps to complete the tasks and one or more information sources relevant to the task of the query, and the high-level planning trained model outputs a high-level plan includes a plurality of steps and information needed to complete the plurality of steps. The method also includes receiving, by a detailed planning agent, the query and the high-level plan, the detailed planning agent having one or more detailed planning agent trained models, where the detailed planning agent is operable to automatically generate a detailed planning agent prompt including the plurality of steps, a plurality of tools, and one or more parameters for each tool of the plurality of tools. The detailed planning agent outputs a detailed plan that includes the plurality of steps and for each step one or more tools and one or more parameters for each of the one or more tools. The method also includes receiving, by an action agent, the query and the detailed plan, the action agent having an action agent trained model, where the action agent is operable to automatically generate an action agent prompt that includes a function call for each tool of the one or more tools of the plurality of steps and one or more parameters for each tool of the one or more tools of the plurality of steps. The action agent produces an execution output including information produced by the function call for the one or more tools of the plurality of steps. The method also includes receiving, by a writing agent, the query and the execution output, where the writing agent outputs a description of results of a completion of the tasks represented by the query.

In another embodiment, a computing apparatus for automatically completing a task includes one or more processors and a non-transitory, computer-readable medium. The non-transitory, computer-readable medium stores instructions that, when executed by the one or more processors, cause the one or more processors to receive, by a high-level planning agent, a user query relating to the task, the high-level planning agent having a high-level planning trained model, where the high-level plan agent is operable to automatically generate a high-level planning agent prompt that requests a plurality of steps to complete the tasks and one or more information sources relevant to the task of the query. The high-level planning agent trained model outputs a high-level plan includes a plurality of steps and information needed to complete the plurality of steps. The instructions also cause the one or more processors to receive, by a detailed planning agent, the query and the high-level plan, the detailed planning agent having one or more detailed planning agent trained models, where the detailed planning agent is operable to automatically generate a detailed planning agent prompt that includes the plurality of steps, a plurality of tools, and one or more parameters for each tool of the plurality of tools. The detailed planning agent outputs a detailed plan that includes the plurality of steps and for each step one or more tools and one or more parameters for each of the one or more tools. The instructions also cause the one or more processors to receive, by an action agent, the query and the detailed plan. The action agent includes an action agent trained model, where the action agent is operable to automatically generate an action agent prompt includes a function call for each tool of the one or more tools of the plurality of steps and one or more parameters for each tool of the one or more tools of the plurality of step. The action agent produces an execution output that includes information produced by the function call for the one or more tools of the plurality of steps. The instructions also cause the one or more processors to receive, by a writing agent, the query and the execution output, where the writing agent outputs a description of the results of a completion of the tasks represented by the query.

These and additional features provided by the embodiments described herein will be more fully understood in view of the following detailed description, in conjunction with the drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example user interface for completing a complex task according to one or more embodiments described and illustrated herein.

FIG. 2 illustrates a workflow of a sequential retrieval-augmented generation system and method according to one or more embodiments described and illustrated herein.

FIG. 3 illustrates a workflow of an example high-level planning agent according to one or more embodiments described and illustrated herein.

FIG. 4 illustrates an example high-level plan output according to one or more embodiments described and illustrated herein.

FIG. 5 illustrates a workflow of an example detailed planning agent according to one or more embodiments described and illustrated herein.

FIGS. 6A and 6B illustrate an example detailed planning agent output according to one or more embodiments described and illustrated herein.

FIG. 7 illustrates a workflow of an example action agent according to one or more embodiments described and illustrated herein.

FIG. 8 illustrates an example execution of an action agent according to one or more embodiments described and illustrated herein.

FIGS. 9A and 9B illustrates example inputs into a writing agent according to one or more embodiments described and illustrated herein.

FIG. 10 illustrates an example output of an example sequential retrieval-augmented generation system according to one or more embodiments described and illustrated herein.

FIG. 11 illustrates an example computing apparatus for a sequential retrieval augmented generation method according to one or more embodiments described and illustrated herein.

### DETAILED DESCRIPTION

Embodiments of the present disclosure solve the current deficiencies of current large language model (LLM) based agents by the use of sequential retrieval-augmented generation. Multiple agents take on sub-tasks of a complex task sequentially, requirement minimal intervention. By prioritizing a structured, step-by-step approach that adds incremental detail to instructions, the sequential retrieval-augmented generation systems and methods described here make complex problem-solving in artificial intelligent agents more achievable. The logic behind sequential retrieval-augmented generation is to establish the order of tools and their settings at the outset, and then enhance and fine tune the tools and settings as the process progresses through each stage. In other words, the process begins with an overview of the goals and the broad steps a system needs to achieve those goals. Then, details are progressively added at each step to ensure the precision needed for each tool to reach its objective.

The architecture of the embodiments of the present disclosure is based on four specialized agents, with each responsible for a specific function. At the top level is the High-Level Planning Agent, which generates a broad, step-by-step plan to guide the process and considers any useful information from the conversation history. Then, the Detailed Planning Agent refines this high-level plan by selecting specific tools and defining parameters. Next, the Action Agent executes each step in sequence, retrieves the results, and stores them for context in subsequent action steps. Finally, the Writing Agent combines responses from each completed step to produce a coherent response in your desired format.

Various embodiments of systems and methods for completing complex tasks using sequential retrieval-augmented generated are described in detail below.

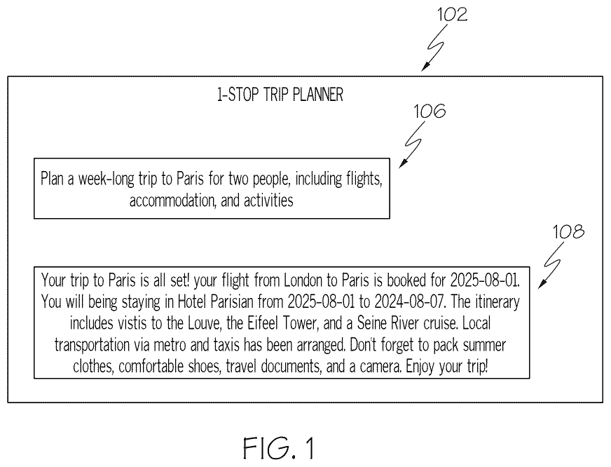

Referring now to FIG. 1, an example user interface 102 according to embodiments of the present disclosure is illustrated. The example user interface 102 provides a trip planning tool, where a user can enter a query describing details of a trip he or she wants to take. It should be understood that embodiments are not limited to trip planning, and that the user interface 102 may be provide a tool that performs any type of function.

Other examples include conducting a competitive analysis of a product and developing an evidence-based strategic approach, creating a comprehensive, personalized care plan for an elderly diabetic patient, optimizing an investment portfolio according to specific risk tolerances and real-time market conditions (handling all the research and actions automatically), and reviewing and analyzing contracts, proposals, or historical rulings to support a legal dispute, without the usual manual searching, reading, and decision-making.

The user interface 102 of FIG. 1 includes an input text box for a user to enter a query in the form of a request. Here, the user has entered “Plan a week-long trip to Paris for two people, including flights, accommodation, and activities.” It should be understood that embodiments may also include speech processing capabilities such that a user may speak the query into the system.

As described in more detail below, the system, which includes multiple agents that take a step-wise approach to fulfilling the request, develops a plan, takes action on that plan, and then produces a summary for the user to view. The summary of the example of FIG. 1 is provided in output text box 108. The system used tools available to it to book flights, a hotel room and activities. A summary of the trip that was booked is provided in the output text box 108, which indicates the dates of travel, hotel information, activity information and packing recommendations. The user may ask further questions about the trip to the system to gain additional information as needed.

The system took the complex task of booking a trip, broke it down into a high level plan having multiple steps (e.g., book a flight, book a hotel, and the like), identified which tools to use (e.g., flight booking website, hotel booking website, and the like), identified which parameters to send to the tools (e.g., dates, number of people, city of travel and the like), executed the plan by sending the parameters to the various tools, and then generated a report that was provided to the user in the output text box 108.

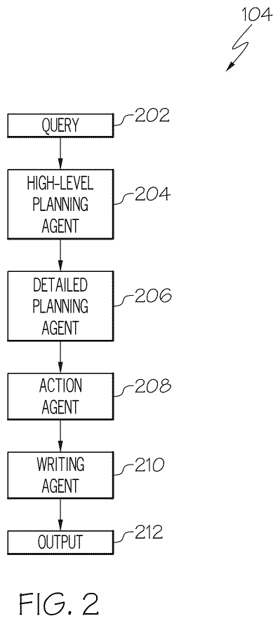

FIG. 2 illustrates a high-level view of an example system 104 for providing sequential RAG to perform complex tasks that minimizes noise, increases consistency and reliability and reduces computational power and time over traditional large-language model methods. The example system includes a high-level planning agent 204 that receives a query 202 from a user, a detailed planning agent 206 that receives the output from the high-level planning agent 204 and the query 202, an action agent 208 that receives the output from the detailed planning agent 206 and the query 202, and a writing agent 210 that receives the output from the action agent 208 and the query 202 and produces an output 212 that is delivered to the user.

Each of the four agents shown in FIG. 2 are responsible for a specific function within the sequential RAG framework. As described in more detail below, the high-level planning agent 204 generates a broad, step-by-step plan to guide the process and considers any useful information from a conversation history based on previous interactions with the system 104. Then the detailed planning agent 206 refines this high-level plan by selecting specific tools and defining parameters. Next, the action agent 208 executes each step in sequence, and stores them for context in subsequent action steps. Finally, the writing agent 210 combines responses from each completed step to produce a coherent response in a desired format.

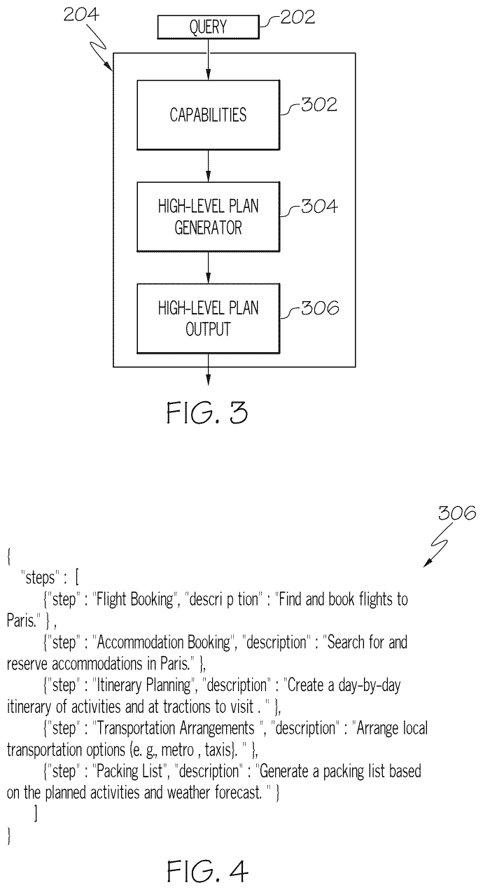

FIG. 3 illustrates the high-level planning agent 204 in greater detail. Generally, the high-level planning agent 204 creates a broad plan outlining a plurality of steps without tool specifics. It utilizes prompt engineering to delineate available APIs, tools, and information sources.

The high-level planning agent 204 automatically generates a prompt that is provided to a high-level planning agent trained model. The high-level planning agent 204 system prompt includes information about the types of data the system 104 can access, the logical sequence the high-level planning agent trained model should follow, and any inherent limitations or restrictions of the system it is planning for. The prompt also asks whether the system 104 can answer the question, and, if yes, what information is needed. If the answer is no, the system 104 may then inform the user that it is not possible to answer the question or perform the tasks that is requested by the query 202.

The high-level planning agent trained model of the high-level planning agent 204 may be a smaller model, such as LLAMA 8B, or GPT-3.5/4o-mini.

The high-level planning agent 204 receives a query 202 from the user. The capabilities 302 of the system are evaluated. The capabilities 302 include the sources of information available to the system 104, such as information sources and tools that are available. In the example of FIG. 1, the capabilities 302 may include travel booking websites and tourist information. The prompt that is generated asks whether or not the question can be answered by evaluating the capabilities 302. If yes, a high-level plan generator 304, which may include the high-level planning agent trained model, generates a high-level plan output 306, which includes a plurality of steps without a lot of additional information. As a non-limiting example, the high-level plan output 306 may be a text file, such as a JSON file.

The high-level planning agent 204 abstracts the overall problem-solving process, allowing for more focused and efficient planning in subsequent stages. Additionally, because the detailed planning agent 206 follows the high-level planning agent 204, it provides a quick way to check the overall logic during debugging without having to wait for the entire process to finish.

FIG. 4 illustrates an example high-level plan output 306 from the travel planning example of FIG. 1. The query requesting the system 104 to book a trip to Paris has been broken up into a plurality of steps by the high-level planning agent 204. The steps are “Flight Booking,” “Accommodation Booking,” “Itinerary Planning,” “Transportation Arrangements,” and “Packing List.” It is noted that the high-level planning agent 204 inferred that a packing list would be beneficial even though it was not specifically requested by the user. Each step also includes a high-level description of what is to be performed by the particular step. For example, for the step “Flight Booking,” the description that is provided is “Find and book flights to Paris.”

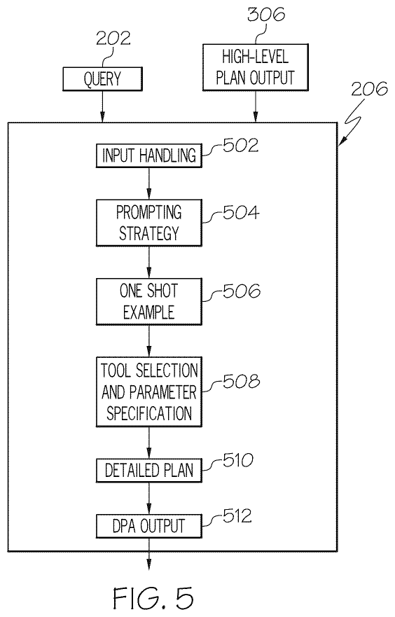

FIG. 5 illustrates the detailed planning agent 206 in greater detail. Both the query 202 and the high-level plan output 306 is provided to the detailed planning agent 206. Using the query 202 and the high-level plan output 306 as a guide, the prompt of the detailed planning agent 206 incorporates comprehensive information about each available tool, including specific usage instructions and the parameters available. This structured approach helps the detailed planning agent 206 refine the plan, select tools and add parameters, taking into account the outputs of prior steps to ensure each subsequent action builds logically on the last. It should be understood that the arrangement of the blocks of the detailed planning agent 206 illustrated by FIG. 5 is non-limiting, and that no particular arrangement of the steps/tasks represented by the blocks is necessary or implied. It is noted that all or some of the blocks of FIG. 5 may be provided by a single prompt or multiple prompts.

The input handling block 502 receives the high-level plan output 306 and ensures that all relevant details, including prior outputs and needed parameters, are available before refining the plan further. Thus, the input handling block 502 acts as a pre-processing step to consolidate the user's intent before tool selection. As a non-limiting example using the trip planning example described above, if the user does not specify a location for the trip, the parameter of “destination” is missing. In this case, the input handling block 502 will cause the process to cease, and generate an output that lets the user know that he or she did not specify the destination.

The prompting strategy block 504 determines how the detailed planning agent 206 will construct the detailed plan. The prompting strategy block 504 includes structured prompts and explicit tool instructions to generate a precise execution plan. The prompting strategy block 504 provides information as to the tools that are available to the detailed planning agent trained model, asks the detailed planning agent trained model to generate a detailed research plan using tools that are provided. The detailed planning agent trained model may be a more capable model to manage the complexity of tool selection and parameter specification. Non-limiting examples of the detailed planning agent trained model include GPT4o+, o1, Claude 3.5+, and Llama 3+70B. The prompting strategy block 504 also includes some guidelines as to the research tasks, such as what makes for a good plan, and how the output of the detailed planning agent 206 should be formatted. The detailed planning agent 206 also includes information as to how to interact with the tools that are available, API interfaces, and how to write queries for searching.

The one-shot example block 506 of the detailed planning agent 206 prompt provides one or more one shot examples, which may include particular steps, the tools called for the particular steps, the parameters selected for the tools that are called, and the format of the output. Any number of one shot examples may be included. As a non-limiting example, a one-shot example may be selection of a flight booking tool and associated parameters for the step of booking a flight. The inclusion of one-shot example(s) may improve the accuracy and reliability of the detailed planning agent 206.

At the tool selection and parameter specification block 508, for each step of the high-level plan, the prompt asks the detailed planning agent trained model to return the best tool to accomplish the step. For example, for the “Flight Booking” step of the high level high-level plan output 306, the detailed planning agent trained model would select a flight booking tool, which is one of the many tools provided to the detailed planning agent trained model of the detailed planning agent 206. As a non-limiting example, the tool selection and parameter specification block 508 portion of the prompt of the detailed planning agent 206 may state “Select the most relevant tool for each step of the plan based on the information you are trying to gather. For comparing entities like institutions, use separate tools for each entity.”

For each tool that is selected, the tool selection and parameter specification block 508 of the prompt asks the detailed planning agent trained model to provide specific parameters for using the tool to accomplish the tasks of the step. As a non-limiting example, the tool selection and parameter specification block 508 may state “Provide the specific parameters that should be passed to each tool based on the example usage provided.” In the trip planning example above, the parameters that are selected may include departure airport, destination airport, departure date and return date. Thus, the detailed planning agent 206 would return these parameters along with a selected flight booking tool for the Flight Booking step of the high-level plan.

The detailed planning agent 206 outputs a detailed plan 510 listing each tool for each step and the associated parameters for each step. Because the detailed plan 510 may include more information than is needed for the action agent 208, a filtering step may be included that filters out unneeded information, such as parameters that are not required, and also formats the detailed plan 510 into a formatted DPA output 512 that includes only relevant information. As a non-limiting example, the detailed plan 510 may include irrelevant information, such as, without limitation, the tail number of a plane flying a route of a selected flight. This irrelevant information can be removed from the detailed plan 510 in the DPA output 512. The DPA output 512 may be a JSON file, for example.

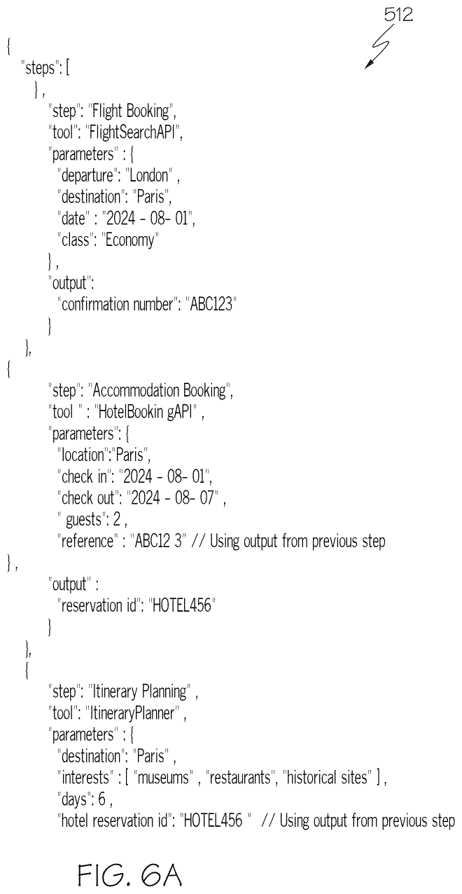

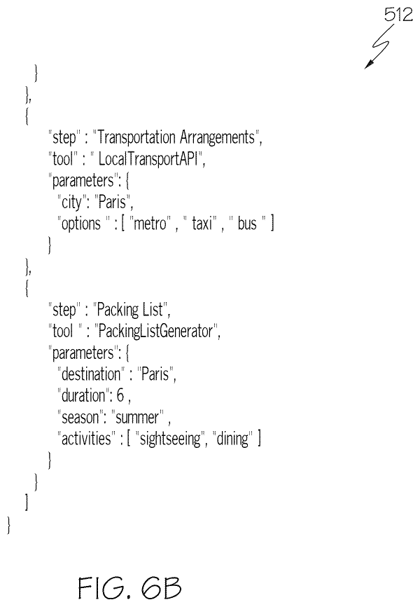

FIGS. 6A and 6B illustrate an example DPA output 512 for the trip planning example. For each step, a tool and associated parameters are specified. The output for the particular step is also specified. For the Flight Booking step, the tool FlightSearchAPI is specified. Parameters such as “departure”: “London” are also specified. It is noted that the DPA output 512 lists the steps sequentially according to a logical order reflective of how a human would perform the overall tasks. The output from the previous step is used by a current step. For example, a hotel booking step would use flight information from the flight booking step so that a hotel room is not booked for a date and time before the passenger will arrive, or for a date and time much later after landing.

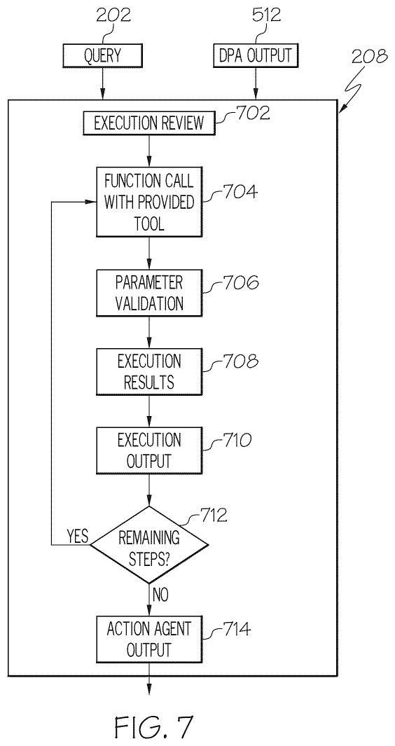

Referring now to FIG. 7, the query 202 and the DPA output 512 are provided to the action agent 208. The action agent 208 is operable to process the DPA output 512 from the detailed planning agent 206 in a step-by-step sequence. As described in more detail below, the action agent 208 calls the specified tool using the specified parameters provided by the detailed planning agent 206, and validates/adjusts the parameters based on instructions embedded with function calls. The action agent 208 has temporal memory, so it is able to reference parameters from previous steps, such as using a country ID retried earlier to look up flights. This approach helps ensure that each step is executed precisely and efficiently, closely following the detailed plan set by the DPA.

At block 702, an execution review is performed to ensure that the action agent 208 is capable of executing the function calls of the DPA output 512. If not, the action agent 208 may output a message to the user indicating that the plan cannot be executed. The action agent 208 may also make recommendations as to changes to the plan that would help in executing it.

At block 704, a function call to the tool of the first step is executed. The function call passes the parameters associated with the step of the DPA output 512. For example, for the Flight Booking step, the FlightSearchAPI tool is called while passing parameters for “departure,” “destination,” “date,” and “class.” Block 706 is provided for parameter validation to ensure that the parameters that are provided are correct. Parameter validation at block 706 may be performed by the function/tool itself. In some embodiments, the action agent 208 includes a small large language model (e.g., GPT3.5 or GPT4o-mini) that is used for parameter correction when the function returns an error. For example, the format of the parameter that is passed to the function may not be correct for the particular function. The small large language model may receive an error from the function and then make suggestions on a new format for the parameter. As an example, the “destination” parameter may be “Great Britain” but the function may require the ISO 3166 country code of “GB.” In this case, the small large language model of the action agent 208 may receive the error from the function and generate a reformatted destination parameter as “GB” and call the function again with the reformatted destination parameter. The small large language model may handle edge cases and therefore adds robustness without having significant detriments to performance enhancement.

A successful function call produces execution output at block 710. The execution output includes information provided by the function or tool. In the Flight Booking step, the execution output will include flight itinerary information.

At block 712 it is decided whether or not there are additional steps to perform. If yes, the function for the next step is called at block 704 and the process repeats until all of the steps of the DPA output 512 are completed. As functions are successfully called, their outputs are appended to the action agent output 714. Thus, the action agent output at action agent output 714 includes all of the information outputted by each function.

FIG. 8 illustrates an example execution of the step Flight Booking by the action agent 208. Here, the execution is performed by calling “FlightSearchAPI.search_flights” along with the parameters for the departure, destination, date and class. The result will be the booking of a flight along with confirmation and itinerary information.

Referring once again to FIG. 2, the action agent output 714 (FIG. 7) is provided as an input to the writing agent 210 along with the query 202. The writing agent 210 includes a writing agent trained model that receives the action agent output 714 and synthesizes it into a response for the user. The writing agent 210 draws on information from each step as provided by the action agent output 714. The prompt of the writing agent 210 is such that the output of the writing agent 210 is a desired narrative in relation to the user's query 202. The writing agent 210 ensures that the final output is not just a collection of individual responses but a comprehensive narrative that fully addresses the user's original query 202 based on the information provided. Depending on the application needs. the writing agent 210 can generate concise summaries, detailed narratives, or structured data outputs, ensuring the final result is coherent and useful.

The choice for the model of the writing agent trained model depends on the number of responses expected per agent request and the desired presentation style. For simple tasks, the smallest effective model may be use. For more complex tasks the considers a lot of data, a larger foundation model should be chosen. For lightweight, low-data tasks (e.g., trip planning), smaller models like GPT-3.5-turbo or GPT-4o mini may be used for efficiency. For heavy-lift synthesis, such as analyzing institutional performance in a publication system such as SciVal operated by Elsevier of Amsterdam, Netherlands, a more capable model may be used, such as GPT-3.5+, Claude 3.5+, Llama 3+ 70B, or a specialist reasoning model such as o1/o3.

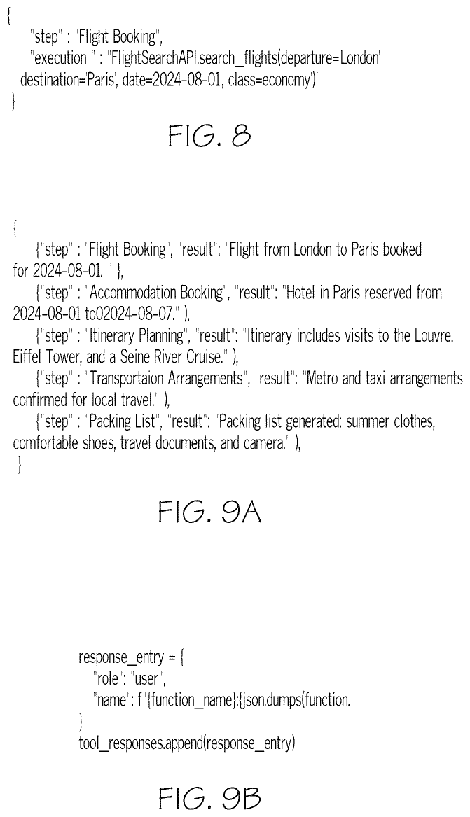

FIG. 9A illustrates an example simplified input to the writing agent 210. In addition to what is shown in FIG. 9A, the input into the writing agent 210 includes a rich and structured input drawn from the full action agent 208 execution trace. Each step's output includes, at least, 1) function name and full argument dictionary, 2) raw API/tool results, 3) any error messages or correction steps (e.g., parameter validation), and 4) meta-data such as IDs, scores, source context, and the like. FIG. 9B illustrates pseudo code how the above information is managed within the tool_responses array in functions such as call_tool_functions. The responses are later passed to the writing agent 210 via, for example:
final_input_messages=AgentPromptsV2.final_writing_agent_prompt(plan json, tool_responses, last_user_query_messages).

Accordingly, FIG. 9A shows a digest, and, as shown by FIG. 9B, the actual input includes several layers of structured data for the writing agent 210 to create an accurate and context-aware output. For example, when booking a hotel, it should align the dates with the user's flight, and those details come from the execution context stored step-by-step.

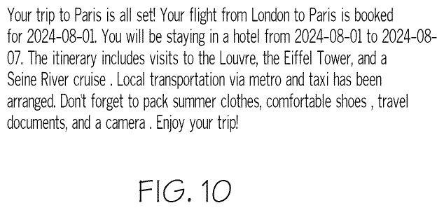

FIG. 10 illustrates an example writing agent output for the trip to Paris example. As shown in FIG. 10, the output is in a pleasant narrative form that provides the user will all of the information relating to the trip. It should be understood that the narratives for other applications will be different from that in FIG. 10. For example, in a scientific research application, the output of the writing agent may include lists of information, tables, graphs and the like. The output may be much more comprehensive and detailed than what is shown in FIG. 10.

The output may also include links to documents relating to the query. In the present example, the output may include links or documents such as flight booking receipt, hotel receipts and other supporting documents. The user may also query the system to provide more information regarding what was provided in the original output. For example, the user may ask the system to provide the address of the hotel, or ask about the check-in time.

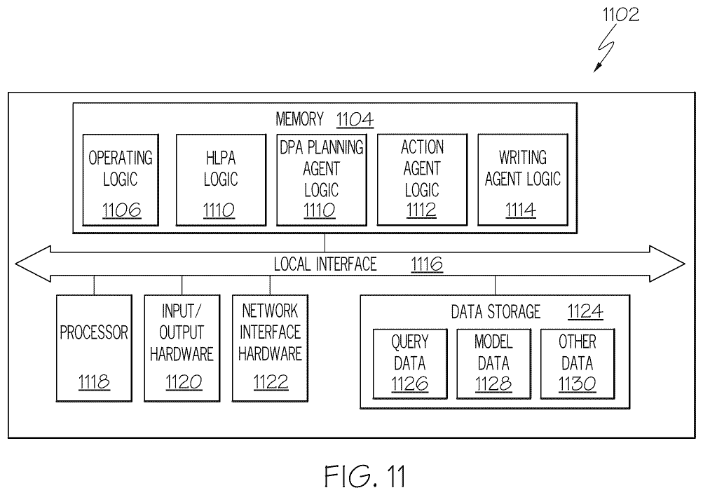

Referring now to FIG. 11, an example computing apparatus 1102 is illustrated. The example computing device provides a system for sequentially completing complex tasks using one or more agents, and/or a non-transitory computer usable medium having computer readable program code for sequentially completing complex tasks using one or more agents embodied as hardware, software, and/or firmware, according to embodiments shown and described herein. It should be understood that the software, hardware, and/or firmware components depicted in FIG. 11 may also be provided in other computing apparatuses or devices external to the computing apparatus 1102 (e.g., data storage devices, remote server computing devices, and the like).

As also illustrated in FIG. 11, the computing apparatus 1102 (or other computing apparatus) may include one or more processors 1118. input/output hardware 1120, network interface hardware 1120, a data storage component 1124 (which may store query data 1126, model data 1128, and any other data 1130 for performing the functionalities described herein), and a non-transitory memory component 1104.

The query data 1126 includes one or more user queries provided to the computing apparatus 1102. The model data 1128 includes any data for operation of the trained models described herein. It should be understood that the data storage component 1124 may reside local to and/or remote from the computing apparatus 1102, and may be configured to store one or more pieces of data for access by the computing device 1102 and/or other components.

The non-transitory memory component 1104 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 1104 may be defined by transitory memory and/or signals.

Additionally, the memory component 1104 may be configured to store operating logic 1160 that provides a local operating system for the computing apparatus 1102, HLPA logic 1108 defining the high-level planning agent that generates a high-level plan using a high-level planning agent prompt and a high-level planning agent trained model, DPA planning agent logic 1110 defining the detailed planning agent that generates a detailed plan using a detailed planning agent prompt and a detailed planning agent trained model, action agent logic 1112 defining the action agent that executes the detailed plan, and writing agent logic 1114 defining the writing agent that generates a written output using a writing agent prompt and a writing agent model (each of which may be embodied as computer readable program code, firmware, or hardware, as an example).

A local interface 1116 is also included in FIG. 11 and may be implemented as a bus or other interface to facilitate communication among the components of the computing apparatus 1102.

The input/output hardware 1120 may include any components for receiving an input or producing an output, such as, without limitation, a keyboard, a microphone, a track pad, a mouse, a touch screen, an electronic display, and a speaker.

The one or more processors 1118 may include any processing component configured to receive and execute computer readable code instructions (such as from the memory component 1104 and/or the data storage component 1124). The network interface hardware 1120 may include any wired or wireless networking hardware, such as a modem, LAN port, wireless fidelity (Wi-Fi) card, WiMax card, mobile communications hardware, and/or other hardware for communicating with other networks and/or devices.

It should be understood that the components illustrated in FIG. 11 are merely exemplary and are not intended to limit the scope of this disclosure. More specifically, while the components in FIG. 11 are illustrated as residing within the computing device 1102, this is a non-limiting example. In some embodiments, one or more of the components may reside external to the computing device 1102.

It should now be understood that embodiments of the present disclosure are directed to systems and methods for completing complex tasks using sequential retrieval augmented generation. Embodiments structured approach to problem-solving emphasizes building in the detail and complexity progressively, which in turn helps the trained model focus on performing its focused tasks faster and more reliably with higher quality outputs at the end.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of automatically completing a task, the method comprising:
receiving, by a high-level planning agent, a query relating to the task, the high-level planning agent comprising a high-level planning trained model, wherein:
the high-level planning agent is operable to automatically generate a high-level planning agent prompt that requests a plurality of steps to complete the tasks and one or more information sources relevant to the task of the query; and
the high-level planning trained model outputs a high-level plan comprising a plurality of steps and information needed to complete the plurality of steps;
receiving, by a detailed planning agent, the query and the high-level plan, the detailed planning agent comprising one or more detailed planning agent trained models, wherein:
the detailed planning agent is operable to automatically generate a detailed planning agent prompt comprising the plurality of steps, a plurality of tools, and one or more parameters for each tool of the plurality of tools; and
the detailed planning agent outputs a detailed plan comprising the plurality of steps and for each step one or more tools of the plurality of tools and one or more parameters for each of the one or more tools;
receiving, by an action agent, the query and the detailed plan, the action agent comprising an action agent trained model, wherein:
the action agent is operable to automatically generate an action agent prompt comprising a function call for each tool of the one or more tools of the plurality of steps and one or more parameters for each tool of the one or more tools of the plurality of steps;
the action agent produces an execution output including information produced by the function call for the one or more tools of the plurality of steps; and
receiving, by a writing agent, the query and the execution output, wherein the writing agent outputs a description of results of a completion of the tasks represented by the query.

2. The method of claim 1, wherein the high-level planning agent prompt further comprises one or more application programming interfaces and the plurality of tools.

3. The method of claim 1, wherein the detailed planning agent prompt further comprises one or more one-shot examples.

4. The method of claim 1, wherein the action agent is further operable to validate the one or more parameters.

5. The method of claim 4, wherein validation of the one or more parameters is rule-based.

6. The method of claim 4, wherein validation of the one or more parameters is accomplished by a validation trained model.

7. The method of claim 1, wherein the action agent is further operable to filter execution results to generate the execution output.

8. A computing apparatus for automatically completing a task, the system comprising:
one or more processors;
a non-transitory, computer-readable medium storing instructions that, when executed by the one or more processors, cause the one or more processors to:
receive, by a high-level planning agent, a query relating to the task, the high-level planning agent comprising a high-level planning trained model, wherein:
the high-level planning agent is operable to automatically generate a high-level planning agent prompt that requests a plurality of steps to complete the tasks and one or more information sources relevant to the task of the query; and
the high-level planning agent trained model outputs a high-level plan comprising a plurality of steps and information needed to complete the plurality of steps;
receive, by a detailed planning agent, the query and the high-level plan, the detailed planning agent comprising one or more detailed planning agent trained models, wherein:
the detailed planning agent is operable to automatically generate a detailed planning agent prompt comprising the plurality of steps, a plurality of tools, and one or more parameters for each tool of the plurality of tools; and
the detailed planning agent outputs a detailed plan comprising the plurality of steps and for each step one or more tools of the plurality of tools and one or more parameters for each of the one or more tools;
receive, by an action agent, the query and the detailed plan, the action agent comprising an action agent trained model, wherein:
the action agent is operable to automatically generate an action agent prompt comprising a function call for each tool of the one or more tools of the plurality of steps and one or more parameters for each tool of the one or more tools of the plurality of steps;
the action agent produces an execution output that includes information produced by the function call for the one or more tools of the plurality of steps; and
receive, by a writing agent, the query and the execution output, wherein the writing agent outputs a description of results of a completion of the tasks represented by the query.

9. The computing apparatus of claim 8, wherein the high-level planning agent prompt further comprises one or more application programming interfaces and the plurality of tools.

10. The computing apparatus of claim 8, wherein the detailed planning agent prompt further comprises one or more one-shot examples.

11. The computing apparatus of claim 8, wherein the action agent is further operable to validate the one or more parameters.

12. The computing apparatus of claim 11, wherein validation of the one or more parameters is rule-based.

13. The computing apparatus of claim 11, wherein validation of the one or more parameters is accomplished by a validation trained model.

14. The computing apparatus of claim 11, wherein the action agent is further operable to filter execution results to generate the execution output.

15. A system for automatically completing a task, the system comprising:
a high-level planning agent comprising a high-level planning agent trained model that receives a query relating to the task, and outputs a high-level plan comprising a plurality of steps and information needed to complete the plurality of steps;
a detailed planning agent comprising one or more detailed planning agent trained models that receives the query and the high-level plan, and outputs a detailed plan comprising the plurality of steps and for each step one or more tools and one or more parameters for each of the one or more tools;
an action agent comprising an action agent trained model that receives the query and the detailed plan and executes a function call for each tool of the one or more tools of the plurality of steps and produces an execution output include information produced by the function calls for the one or more tools of the plurality of steps; and
a writing agent comprising a writing agent trained model that receives the query and the execution output and outputs a description of results of a completion of the tasks represented by the query.

16. The system of claim 15, wherein the high-level planning agent is operable to automatically generate a high-level planning agent prompt that requests a plurality of steps to complete the tasks and one or more information sources relevant to the task of the query.

17. The system of claim 16, wherein the high-level planning agent prompt further comprises one or more application programming interfaces and a plurality of tools.

18. The system of claim 15, wherein the detailed planning agent is operable to automatically generate a detailed planning agent prompt comprising the plurality of steps, a plurality of tools, and one or more parameters for each tool of the plurality of tools.

19. The system of claim 18, wherein the detailed planning agent prompt further comprises one or more one-shot examples.

20. The system of claim 15, wherein the action agent is operable to automatically generate an action agent prompt comprising a function call for each tool of the one or more tools of the plurality of steps and one or more parameters for each tool of the one or more tools of the plurality of steps.
